(19) United States
(12) Patent Application Publication
(10) Pub. No.: US 2015/0062880 A1
(43) Pub. Date: Mar. 5, 2015

(54) SOLAR POWERED LED MAILBOX LIGHTING ILLUMINATION SYSTEM

(71) Applicant: ROBERT ERNST KLEINSCHMIDT, POWDER SPRINGS, GA (US)

(72) Inventor: ROBERT ERNST KLEINSCHMIDT, POWDER SPRINGS, GA (US)

(21) Appl. No.: 13/866,041

(22) Filed: Apr. 19, 2013

Related U.S. Application Data
(60) Provisional application No. 61/635,408, filed on Apr. 19, 2012.

(51) Int. Cl. F21L 4/08; F21V 23/00; H02J 7/00; H01M 10/46; H02J 7/35; F21K 99/00; F21V 7/00

(52) U.S. Cl. CPC F21L 4/08; F21K 9/50; F21V 23/009; F21V 7/00; F21V 7/0066; H01M 10/465; H02J 7/355; H02J 7/0013; F21Y 2101/02
USPC 362/183; 320/101

(57) ABSTRACT

Device is for a Mailbox or structure utilizing a specially designed Solar Powered Rechargeable Battery Control Box. The Control Box module utilizes a power charging mode during the daylight hours to enable the battery control box module to discharge a current through PORTS that supplies power to MULTIPLE EXTERNAL DEVICES containing an array of Light Emitting Diodes (“LED(s)”) during the dusk to dawn hours. MULTIPLE PORTS are specially designed to connect to the external apparatus and device(s) via specifically designed wiring. The primary Apparatus is a rectangular device consisting of an acrylic surface, reflecting materials, and Alpha/Numeric items. The LED(s) create a light source passed through the edges. A track system allows for materials to be removable. Multiple other apparatus' are plastic/Acrylic designed shapes to represent themes. The LED(s) creates a light source passed through illuminating each shape.

### DESCRIPTION OF DRAWINGS

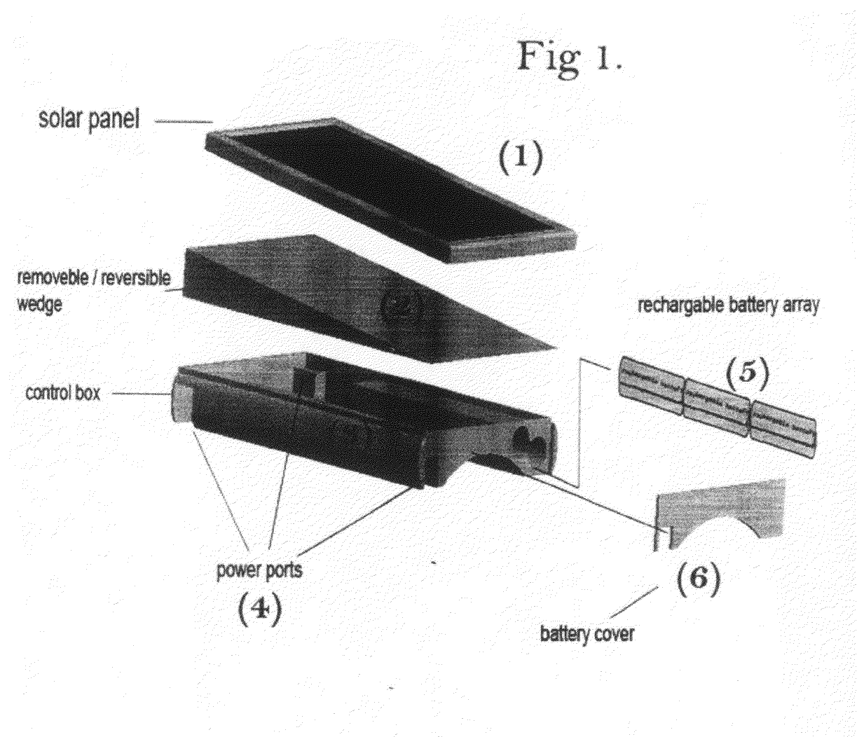

FIG. 1—Solar Panel Battery Powered Control Box—
1) Solar Panel
2) Removable/reversible wedge
3) Control Box
4) Power Ports(3-4)
5) Rechargeable Battery Array
6) Battery cover

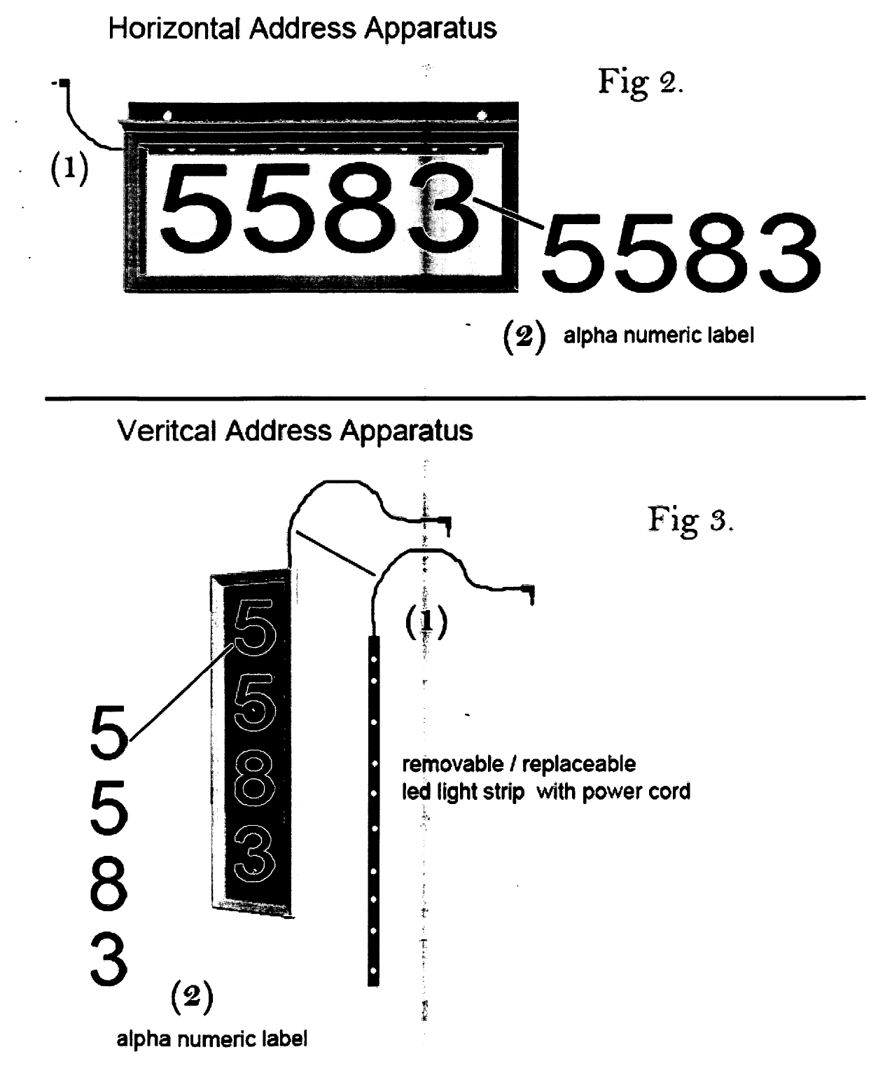

FIG. 2—Address Apparatus—
1) Removable/Replaceable LED Array or Strip of lights with power cord
2) Alpha numeric label

FIG. 3—Vertical Address Apparatus with power cord
1) Removable/Replaceable LED Array or strip of lights with power cord
2) Alpha numeric label

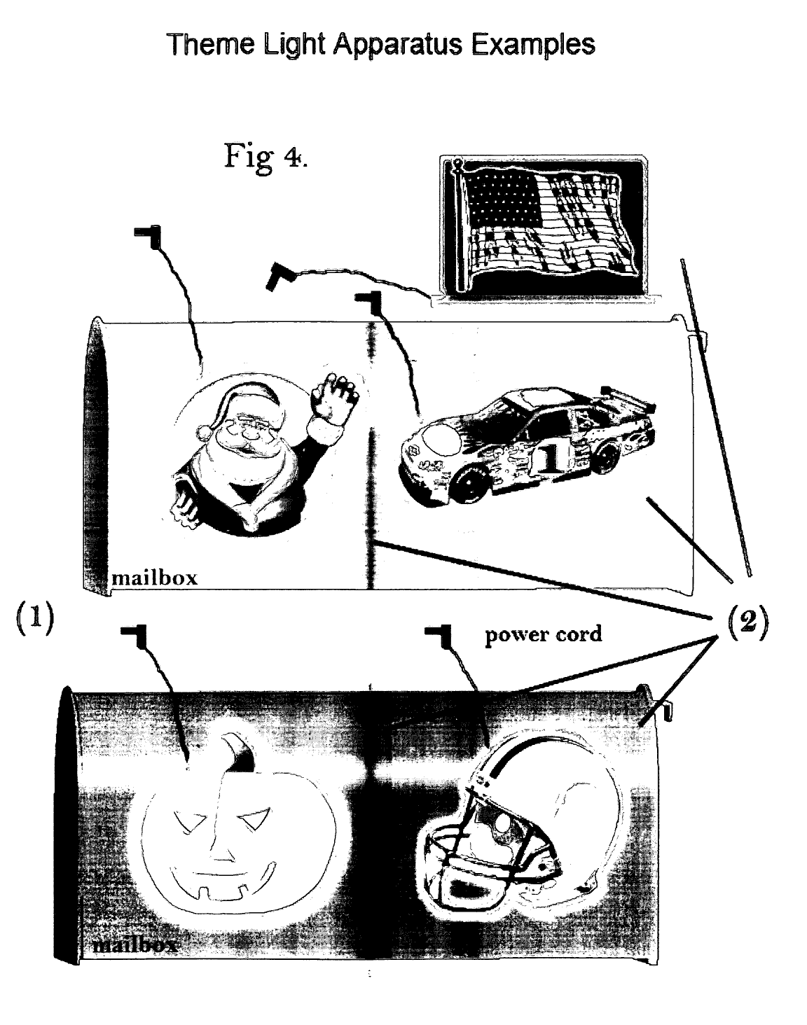

FIG. 4—Theme based Novelty Accessory Devices—
1) Mailbox structure
2) Examples of Accessory Devices that represent Sporting/Athletics, holidays, Events, Patriotism, and Post Lights.

FIG. 1—Power Control Panel: This invention is powered by a solar panel which charges an array of rechargeable batteries. These batteries can be easily changed when the life cycle has been reached. The power pack is very unique in nature being that there are multiple jacks to supply 3 or 4 separate power outlets. The Panel and Battery Box are enclosed in a housing that will mount to top surface of mailboxes of various designs. The design of the housing allows the invention to be mounted to flat surfaces as well as rounded or sloped mailbox designs. The Control Box can be mounted to the different surfaces with heavy duty Polyester tape (off shelf), screws, and/or bolts/nuts or combination thereof. A molded plastic wedge may also be incorporated, or not, to achieve maximum exposure to sunlight. The wedge has the ability to be mounted in either direction or be removed completely.
1) Flat Solar Panel
2) Removable/Reversible Wedge: Used to adjust height and directional position of Solar Panel.
3) Battery Pack that is rechargeable and interchangeable. Batteries supply power to external apparatus via 3-4 separate ports.
4) Power Ports: Uniqueness is the 3 or 4 port connections. A photo sensor (LDR) is utilized to turn on LED's and Apparatus at night and turn off same during daylight hours.
5) Circuit board using wires which controls charging of battery during daylight hours.
6) Battery cover panel

FIG. 2—LED Array Component Horizontal and Vertical Address Apparatus: An Array or strip of LED light source. According to claim 1, where in the LED Array Component receives power via wiring. A rectangular device consisting of a metal or plastic housing frame and containing a rectangular glass or acrylic as the front surface. Whereas light is passed through the edges of said surfaces whereas reflecting tape is used on 3 other edges. Alpha and/or numeric items are used to indicate house address and placed on front surface which contain a reflective surface on the back side. A backing reflective material is placed on backside of glass/acrylic all 4 components—LED-Glass/Acrylic Surface-reflective tape-reflective backing material create a unique holographic reflection of said alpha/numeric items.
7) A Horizontal or Vertical designed frame housing and attached to the Solar Powered Control Box via small gauge wiring with detachable wire plug.
8) Frame housing and Backing plate are constructed of metal, plastic, or a combination of metal and plastic.
9) A special Track built within compartment housing allows for other materials to become removable and interchangeable.
10) Lights can be exchanged with different colors of LED Strips ie. White, Red, Green, Blue, and multicolor combined.
11) Rectangular sheet of glass or acrylic is inserted into frame housing using a track mechanism.
12) Alpha and Numeric indicators made of all weather hard textured plastic with white reflective backing.
13) An array or strip of LED light source is inserted into frame housing using a track mechanism allowing for light source to become removable and interchangeable to create a specific theme.
14) A reflective backing material is inserted into frame housing using a track mechanism allowing for material to become removable and interchangeable to create a specific theme or appearance.

FIG. 3—Theme Based Novelty LED Indcators: Under an array of LED lights encased in a body made from plastic or metal or combination thereof, shaped in various themes comprising of but not limited to Sports/Athletics, Holidays, Patriotism, and Events and Post light.
16) LED lights built into body to illuminate Theme.
17) Theme light to attach to mailbox with magnet, or other fastener
18) Power supplied to Theme Indicator by connecting wiring to main Control box Power Supply to illuminate during night time.
19) Small gauge wire to connected by detachable plug into main Control Box

1) SOLAR PANEL BATTERY POWERED CONTROL BOX: This invention is powered by a solar panel which charges an array of rechargeable batteries. The power control box is very unique in nature being that there are multiple PORTS which supplies power to 1 or up to 4 separate connectors that supply power to the external apparatus and accessory devices. The Solar Panel Battery Powered Control Box is enclosed in a housing that will mount to the top surface of mailboxes of various designs. The design of the housing allows the invention to be mounted to flat surfaces as well as rounded or sloped mailbox designs. The Control Box can be mounted to the different surfaces with heavy duty Polyester tape (off shelf), screws, and/or bolts/nuts or combination thereof.

2) The Solar Panel Battery Powered Control Box of claim 1 where A Circuit board controls the charging of batteries from solar power panel as well as controlling the photo-sensor allowing the batteries to power the external apparatus and accessory devices during nighttime hours.

3) The device of claim 2 wherein a photo-sensor (LDR) to turn on LED's within the External Apparatus and Accessory Devices at night and turn off same during daylight hours.

4) The Solar Panel Battery Powered Control Box of claim 1 wherein Blocking diodes are used to keep the current from traveling from the batteries to the solar panel as well as from the solar panel to the external apparatus and accessory devices.

5) The Solar Panel Battery Powered Control Box of claim 1 wherein A molded plastic wedge may also be incorporated to achieve maximum exposure to sunlight enabling the solar panel to recharge the batteries more effectively. The wedge has the ability to be mounted in either direction or be removed completely.

6) The Solar Panel Battery Powered Control Box of claim 1 wherein VERY UNIQUE Multiple Ports (1-4) are used to supply Power to external apparatus and accessory devices.

7) SOLAR PANEL BATTERY POWERED CONTROL BOX is powered by a solar panel which charges an array of rechargeable batteries. The power control box is very unique in nature being that there are multiple PORTS which supplies power to 1 or up to 4 separate connectors that supply power to the External Address Apparatus and Theme Based Novelty Accessory Devices.

8) The Solar Panel Battery Powered Control Box of claim 7 wherein an LED Array Component contains an array or strip of LED light source receiving power through specifically designed connectors from the Control Box. Lights can be exchanged with different colors of LED Strips i.e. White, Red, Green, Blue, and multicolor combined.

9) The Solar Panel Battery Powered Control Box of claim 7 wherein an external Address Apparatus is a rectangular device of horizontal or vertical design consisting of a metal or plastic housing frame and containing a rectangular glass or acrylic as the front surface and attached to Control box via a specially designed connector to the Control Box. Whereas light is passed through the edges of said surfaces whereas reflecting tape is used on 3 other edges. Alpha and/or numeric items are used to indicate house address and placed on front surface which contain a reflective surface on the back side. A backing reflective material is placed on backside of glass/acrylic.

10) The External Address Apparatus of claim 9 wherein A special Track built within compartment housing allows for internal housing materials (such as the LED Array and reflective backing) to become removable and interchangeable to create a specific theme or appearance. The LED array can be changed to utilize different colors for lighting.

11) The Solar Panel Battery Powered Control Box of claim 7 wherein a Theme Based Novelty LED Indicators under an array of LED lights encased in a body made from plastic or metal or combination thereof, shaped in various themes comprising of but not limited to Sports/Athletics, Holidays, Patriotism, Events, and Post light. LED lights are built into the body to illuminate said Theme. Theme light to attach to mailbox with magnet or other fastener. Power supplied to Theme Indicator by connecting wiring to main Control box Power Supply to illuminate during night time.
